(19) United States
(12) Patent Application Publication
(10) Pub. No.: US 2018/0032333 A1
(43) Pub. Date: Feb. 1, 2018

(54) Atomic Line Multi-Tasking

(71) Applicant: Mark Kenneth Sullivan, Houston, TX (US)

(72) Inventor: Mark Kenneth Sullivan, Houston, TX (US)

(21) Appl. No.: 15/664,899

(22) Filed: Jul. 31, 2017

Related U.S. Application Data
(60) Provisional application No. 62/369,162, filed on Jul. 31, 2016.

(51) Int. Cl. G06F 9/30; G06F 9/48

(52) U.S. Cl. CPC G06F 9/3016; G06F 9/3001; G06F 9/30018; G06F 9/30072; G06F 9/4881

(57) ABSTRACT

A novel implementation of multi-tasking in a computer, microprocessor, or the like which provides the advantages of pre-emptive multi-tasking but which mitigates some of the complexities of developing code for reliable execution in a pre-emptive environment.

### RELATED APPLICATIONS

This application claims priority to U.S. Provisional Application No. 62/369,162, filed Jul. 31, 2016.

### BACKGROUND OF THE INVENTION

Basic machine language is atomic, meaning uncuttable. Basic operations such as loading a value into a register, saving a register to memory, adding two numbers, etc are atomic. Computers of all sizes are called upon to multitask. However, a CPU can only perform a single task instruction at a time. A CPU spends a small “quantum” or “slice” of time working on one task, then switches to work for a brief moment on another task, and so on until each task gets some attention. A CPU does this fast enough that the computer appears to be doing multiple things at once. In a typical desktop environment, the quantum of time spent on each process is on the order of 10 milliseconds.

The means of deciding which task gets to use the CPU and when this can occur is called scheduling. Scheduling is a complex topic of continued computer science research. There is no perfect universal solution to scheduling. Scheduling algorithms range from simple “round-robin” schemes where the tasks take turns using the CPU in a fixed order, to priority schemes where interactive tasks (such as moving a cursor or updating a video display) get scheduled more often than less time-critical tasks, such as sending data to a printer. All but the most basic schedulers have a way of skipping processes that don't really need the CPU at the moment because they are waiting for something else to happen.

Scheduling is deciding which process will get the use of the CPU next. A process can relinquish the CPU when the time slice is up or when it needs to wait for something external to the CPU to happen. For instance, some kind of I/O such as reading a disk sector or waiting for a packet to come in over a network may determine whether a process will relinquish the CPU.

The two basic methodologies for giving up the CPU include cooperative and pre-emptive systems. In a cooperative multi-tasking system, each process decides for itself when to give up the CPU. This is called “yielding” the CPU and is often implemented by calling an operating system function named Yield(). In pre-emptive multi-tasking, the operating system forcibly takes the CPU away from a process when the time quantum has expired and passes the CPU to the next task. Pre-emptive systems may also have a Yield() function so a process can give up the CPU voluntarily.

One of the problems with a cooperative multi-tasking system is that if a process doesn't yield the CPU it could tie up the CPU indefinitely, especially if the task has a design flaw. A problem with pre-emptive scheduling is that the task does not know when it will be interrupted, which causes difficulties in programming, especially if multiple processes need to cooperate on a given task. Instructions from one task may inadvertently causes unforeseen problems when the CPU arbitrarily switches to another task.

### SUMMARY OF EXAMPLE EMBODIMENTS

An example embodiment may include a system of automatic data processing including a CPU which executes instructions, a first timer establishing a time interval, a means to change the sequence of instruction execution, a means to manage the execution of a plurality of tasks, and an instruction decoder which, in addition to the prior-art functions of such a decoder, recognizes a special condition. The combination of the time interval expiration and the special condition being detected causes a sequence of instruction execution changes, thus stopping the CPU from executing the instructions comprising one task and then executing the instructions comprising a second task. The means to change the sequence of instruction execution may include a scheduler which may include code executed on a CPU. The means to manage the execution of a plurality of tasks may include a scheduler, a compiler, an interrupt control, a program counter, and/or instruction decoder. The comparison means which triggers pre-emption may include an AND gate, which may include a plurality of transistors. The comparison means may also exist as code executed on a CPU.

A variation of the example embodiment may further comprise data memory, program memory, an input/output interface, and/or an Arithmetic Logic Unit. The example embodiment may include a bus for sending a plurality of signals from the data memory to the Arithmetic Logic Unit. It may include a second timer. The second timer may be the first timer with a comparison means which triggers preemption when the count value exceeds a second predetermined count that is greater than the first predetermined count even if the instruction decoder has not detected the special condition. The special condition may be a special-purpose instruction. The special condition may be a modified version of an ordinary instruction. The instruction modification may be a special-purpose bit in the instruction word. The instruction modification may be a special value of a multi-bit field of the instruction word.

An example embodiment may include a method for invoking a multi-tasking scheduler in an operating system running on a CPU including running a first task originally written in high-level instructions and subsequently translated into a series of low-level instructions, concurrently measuring an interval of time, detecting the concurrence of the end of the sequence of low-level instructions representing a plurality of high-level instructions and the expiration of the time interval, and on such detection, reconfiguring the CPU to execute the instructions of a second task.

A variation of the example embodiment may include the plurality of high-level instructions being a single line of text encoding a high-level computer language. The end of a first sequence of low-level instructions representing a plurality of high-level instructions and the beginning of a subsequent sequent of low-level instructions representing a subsequent plurality of high-level instructions may be delimited by a compiler, which may translate said high-level instructions into functionally equivalent sequences of low-level instructions. The end of a first sequence of low-level instructions representing a plurality of high-level instructions and the beginning of a subsequent sequent of low-level instructions representing a subsequent plurality of high-level instructions may be delimited by a post-processing software program which may modify the output of a compiler which translates said high-level instructions into functionally equivalent sequences of low-level instructions. The interval of time may be measured by a hardware timer or counter. The interval of time may be measured by a software interrupt routine invoked periodically by a periodic interrupt and which counts the number of such invocations to measure intervals of time.

Further variation of the example embodiment may include the reconfiguration of the CPU being performed by a small subprogram which saves the state of the CPU as it was when executing a first task and restores the state of the CPU to that which it needs to execute a second task. The subprogram may be invoked by an interrupt. The delimiting of the two sequences of low-level instructions may be in the form of a special low-level instruction recognized by a CPU implemented to embody the invention which causes the invocation of the scheduler if the time interval has also expired. The delimiter may be a modification to the last instruction of the first sequence or the first instruction of the second sequence. The delimiter may be a short sequence of standard instructions of a CPU which has not been specifically modified to embody the invention. The modification may be the modification of a special bit in a standard instruction word. The modification may be a special value of a multi-bit sub-field of an instruction. The concurrence may trigger an interrupt. The example embodiment may further include reconfiguring the CPU at the end of a second, longer, time interval if the concurrence does not occur within that longer time.

### BRIEF DESCRIPTION OF THE DRAWINGS

For a thorough understanding of the present invention, reference is made to the following detailed description of the preferred embodiments, taken in conjunction with the accompanying drawings in which reference numbers designate like or similar elements throughout the several figures of the drawing. Briefly:

FIG. 1 depicts a flow chart of a microprocessor computation.

FIG. 2 depicts a flow chart of a microprocessor computation embodying the invention.

FIG. 3 depicts a microprocessor layout.

FIG. 4 depicts a microprocessor layout augmented to embody the invention.

FIG. 5 depicts a comparison between program code, compiled code, and augmented machine code.

FIG. 6 depicts a scheduler switching between multiple tasks in a cooperative multi-tasking system.

FIG. 7 depicts a scheduler switching between multiple tasks in a pre-emptive scheduling system.

FIG. 8 depicts a scheduler switching between multiple tasks in an atomic multitasking system.

FIG. 9 depicts a compiler process.

FIG. 10 depicts a compiler process.

### DETAILED DESCRIPTION OF EXAMPLES OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

The dominant paradigms for multi-tasking have drawbacks. Pre-emptive scheduling is a practical necessity in all but the simplest systems. The pitfalls of unexpected pre-emption are particularly subtle and dangerous in embedded systems which are the digital brains of most modern electronics.

An example embodiment of the claims may require custom hardware added to a CPU. A new instruction is added to the instruction set that test flags placed in the code of a task. If the flag is set, then the code calls a yield function just like an interrupt or other exception. Another method may include placing a special bit, for example an auxiliary bit, in the instruction format. This special bit is set only on the instructions which represent the compiler-inserted yield opportunity. The flag option adds overhead and may reduce system performance by 10 to 15 percent. The auxiliary bit imposes no performance overhead, but does require more memory, and thus more silicon area and therefore higher hardware cost. The increase in memory will be one bit per instruction and the size of an instruction may vary from 8 bits to 64 bits. A reasonable estimate of the impact is an increase in the program memory size by a half a percent.

A modified ARM processor may be able to accommodate this auxiliary bit. It has a “conditional execution” means which allows instructions to be converted to a no-op (operation which does nothing) if the ALU status flags do not match a specified condition. A modified ARM processor could be synthesized and have an additional flag. Conditional execution is controlled by a four-bit field in the instruction word. One of the four bit combinations, all ones, is not used. This code could be used to trigger the testing of a pre-emption-pending flag and the instruction, which would trigger an exception that would only execute if that flag is set.

Another example embodiment may include a CPU implemented in field-programmable gate arrays (FPGA) to have an extra bit that could be used as an auxiliary bit.

Another example embodiment may include an ARM processor in conjunction with a TST instruction. The TST instruction tests the pre-emption-pending flag and transfers it to one of the ALU flags, e.g. Z. The following instruction is configured to conditionally execute on this ALU flag and, if it is set, trigger the exception. The SWI instruction is ideal for this purpose. The compiler may make sure that the value of the Z flag does not need to be preserved between lines. In a typical high-level language such as “C”, this situation will rarely arise as the ALU flags do not correspond to any concept in the high-level language.

The Microchip PIC family of processors does not support conditional execution of the instant instruction but they do have a class of instruction that is a “test and skip.” Based on some condition or comparison, these instructions will or will not cause an instruction to be ignored. A BTSC instruction can test the pre-emption-pending flag and the following instruction can be a subroutine call to a yield function or can set a bit that will cause an exception, such as using BSET to set a bit in one of the interrupt pending registers.

In many high-level languages, it is possible to write a long loop, even an entire program, as a single line of code. This gives the programmer a way to create an ad-hoc critical section of code simply by including the entire critical code sequence in a single line. It also means a programmer can intentionally or inadvertently avoid pre-emption. As a means to mitigate against a programmer avoiding pre-emption, an example embodiment can use two time limits. The first timer, configured to measure the normal time slice, should set the pre-emption-pending flag at a first predetermined time interval. The second timer should be set for a second, longer, predetermined time interval and it should either force pre-emption even though the flow of execution has not reached the end of the source line, or it should cause an error condition forcing the programmer to avoid writing such source lines. Two timers may be implemented as a single counter with comparison means which triggers the two events at different count values.

There are several types of processing loops for performing multitasking operations while also preventing the processor from getting monopolized by one specific task. One example is a cooperative multi-tasking environment (CMTS) where each task has set yield points within its instructions that relinquish the processor. In a cooperative environment there may be a plurality of tasks that are being addressed by a processor. The processor will process through a first task and then when it reaches a yield point within the task code, it will switch to the next task. This allows programmers to build stop points within the code for each task that will effectively yield the processor. Afterwards, that task will wait until the processor handles the rest of the tasks before resuming itself. One of the benefits of this cooperative environment is that the multi-tasking means does not need to know or guess when it is a good time to switch from one task to the next as it is told by the task. One of the negatives of a cooperative environment is that the processor can get hung up on a single task and never relinquishing for other tasks. Early computer operating systems were prone to this condition, causing the computer to become unusable and often requiring the restarting of the computer. Modern embedded electronics may still be prone to this problem.

Another type of processing loop is a pre-emptive multi-tasking environment (PMTE). In a pre-emptive environment the processor decides when to switch from one task to another. The processor will give an arbitrarily decided time slice to each application. This is a system that is used in more modern operating systems. The benefit to the pre-emptive system is that a single task cannot monopolize or crash the processor. The downside to the pre-emptive system is that the processor may end the code in the middle of an instruction sequence that may result in unintended results in the subsequent task. An unforeseen pre-emptive switching between tasks may cause a condition.

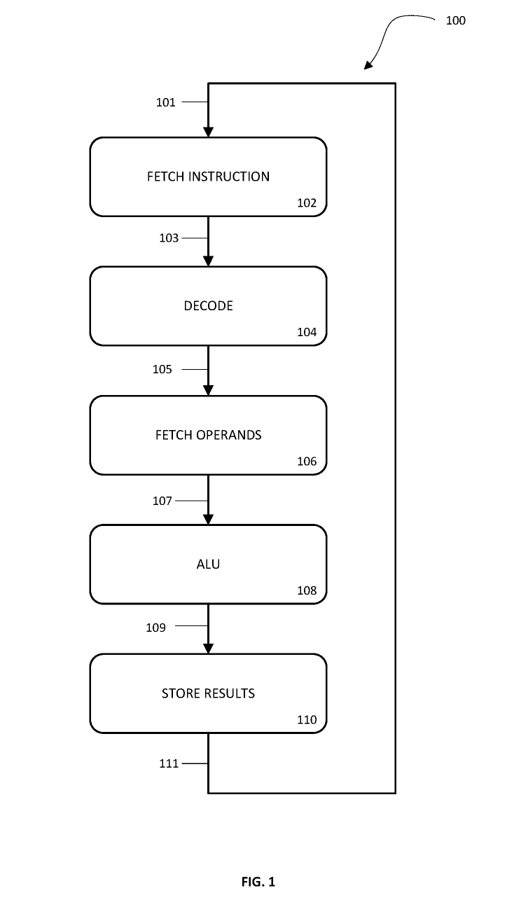

An example embodiment is shown in FIG. 1 depicting the normal execution flow 100 of a typical microprocessor. The execution flow 100 is representative of a computation cycle occurring on a microprocessor. A result 101 from a previous operation is fed into the execution flow of a microprocessor. The microprocessor will fetch instructions 102, usually from the program memory. Then the microprocessor will transmit the instructions 103 from the program memory to the decoder 104. The decoder 104 will decode the transmitted instructions 103 and then output decoded instructions 105. The decoding process 104 decides what steps must be taken to execute the instructions and control signals from the decoder to activate other parts of the processor such as the data memory and the arithmetic and logic unit (ALU) 108. Most instructions require an operand or operands. These one or more operands are transferred in step 106 from the data memory or the input/output (I/O) port to the ALU 108. The ALU 108 calculates the operation commanded 107, which is a combination of the decoded instructions 105 and the fetched operands 106. The ALU 108 then executes the operation and outputs one or more operations 109 that is then stored 110 in typically data memory, I/O port, or the program counter. Typically the stored results 110 occur at a data memory location or are transferred to an I/O port. The output 111 due to the stored results 110 are then fed back into the execution flow 100 and the next instruction is fetched 102.

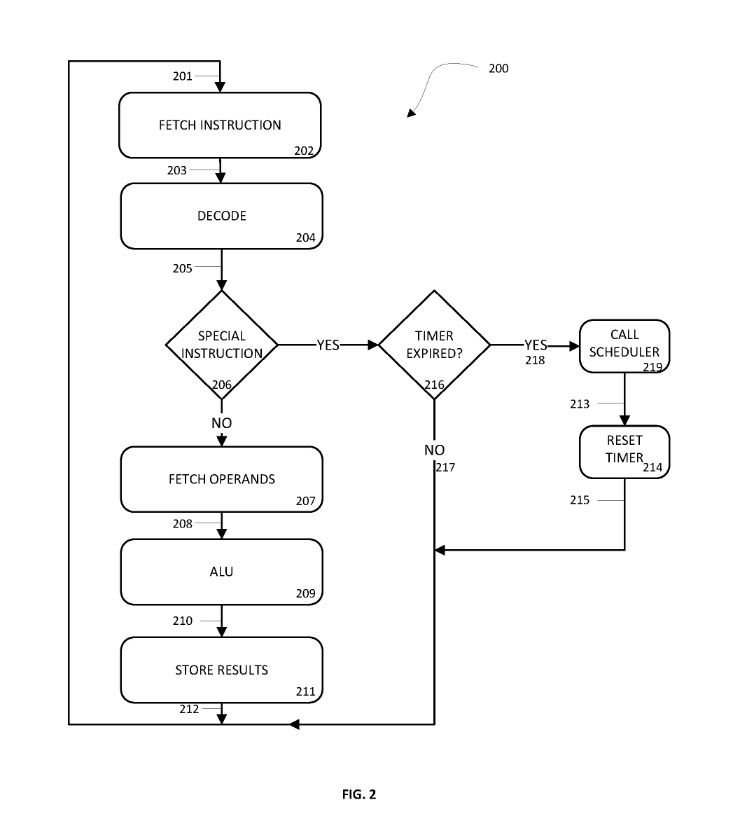

An example embodiment is shown in FIG. 2 depicting the normal execution flow 200 of a typical microprocessor. The execution flow 200 is representative of a computation cycle occurring on a microprocessor. Although execution is continuous and steps may overlap in real hardware, the essence of the process is as follows. To process each machine instruction, the microprocessor first fetches an instruction 202, usually from the program memory. The next step is to decode the instruction 204. Besides the usual functions of such a decoder, the decoder in an embodiment of the invention detects a special instruction 206. When the special instruction is detected, the timer is then tested 216 and if the timer has expired 218 then the scheduler is invoked 219. The scheduler signals 213 the tinier reset 214. The timer is reset 214 and normal processing resumes 215 with the next task with the fetch of the next instruction 201.

If the special instruction 206 is not present and the timer 208 has not expired, then the decoding process 204 continues and decides what steps must be taken to execute the instructions and control signals from the decoder to activate other parts of the processor such as the data memory and the arithmetic and logic unit (ALU) 208. Most instructions require an operand or operands. These one or more operands are transferred in step 206 from the data memory or the input/output (I/O) port to the ALU 208. The ALU 208 calculates the operation commanded 207, which is a combination of the decoded instructions 205 and the fetched operands 206. The ALU 208 then executes the operation and outputs one or more operations 209 that is then stored 210 in typically data memory, I/O port, or the program counter. Typically the stored results 210 occur at a data memory location or are transferred to an I/O port. The output 211 due to the stored results 210 are then fed back into the execution flow 200 and the next instruction is fetched 202. If the special instruction is present and the timer has not expired 215 then the execution continues 217.

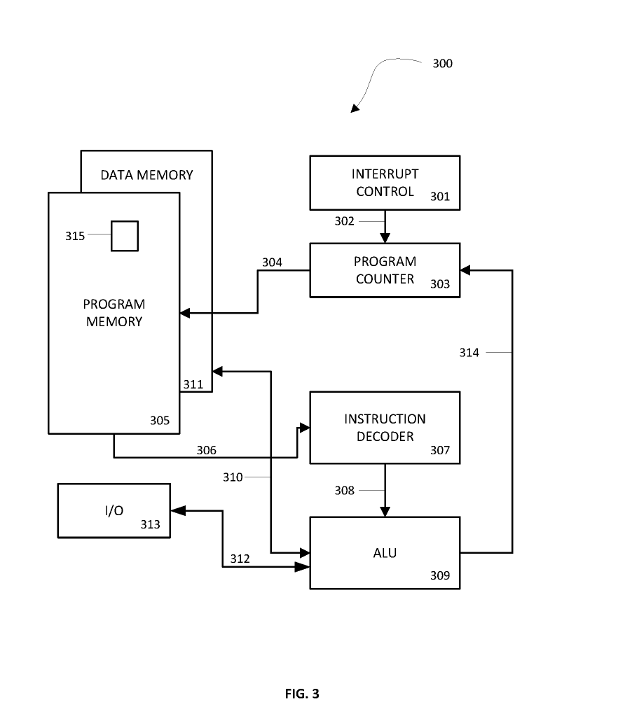

An example embodiment is shown in FIG. 3 showing a block diagram of the hardware components on a typical microprocessor 300. A microprocessor 300 contains memory 305 for storing instructions to be executed. A microprocessor 300 contains a data memory 311 for storing operands and variables. Program instructions 315 are stored in the program memory. In a Von Neuman architecture the memory 305 and the data memory 311 may be one and the same. In a Harvard architecture the memory 305 and the data memory 311 are separated and may not have the same width in bits.

The microprocessor 300 has a program counter 303 which supplies the address 304 of an instruction to be executed. The instruction passes from the program memory 305 via bus 306 to an instruction decoder 307. As discussed in FIG. 1, when a decoding process 104 decides what steps must be taken to execute the instruction, signals along data bus 310 may be sent from the decoder 307 to the data memory 311. Control signals 308 may be sent from the decoder 307 to the ALU 309. Control signals 314 may be sent from the ALU 309 to the program counter 303. Signals along data bus 310 may be transferred between the AIX 309 and the data memory 311. One or more operands may be transferred from the data memory 311 to the ALU 309. Especially in Von Neuman architectures, a single bus may perform the functions of the instruction bus 306 and the data bus 310. Some architectures may separate I/O data from memory data, in which the operand may come from an I/O peripheral 313. The ALU 309 may also send data 314 back to the program counter 303.

The ALU 309 calculates the operation commanded by the instruction decoder 307. The result of the ALU operation is stored via data bus 310 in the data memory 311 or transferred 312 to or from an I/O port 313. The flow of execution can change from time to time by operations that modify the program counter 303. Otherwise, the microprocessor 300 advances the program counter address to the next instruction.

In most microprocessors there is an interrupt control 301. When certain events occur, signals to the interrupt control 301 trigger an interruption in the default flow of instructions. A new address 302, which may be singular or may depend on the source of the interrupt signal, is transferred to the program counter 303 and execution of the interrupt service routine (ISR) begins. When the ISR completes, instruction execution resumes normally at the instruction following the previous instruction that was interrupted.

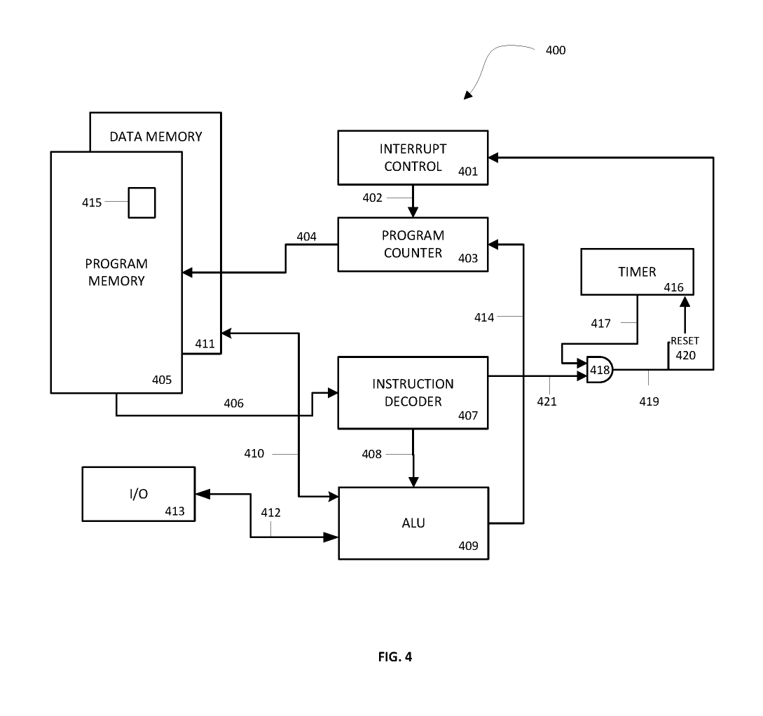

An example embodiment is shown in FIG. 4 showing a block diagram of the hardware components on a typical microprocessor 400. A microprocessor 400 contains memory 405 for storing instructions to be executed. A microprocessor 400 contains a data memory 411 for storing operands and variables. In a Von Neuman architecture the memory 405 and the data memory 411 may be one and the same. In a Harvard architecture the memory 405 and the data memory 411 are separated and may not have the same width in bits.

The microprocessor 400 has a program counter 403 which supplies the address 404 of an instruction to be executed. The scheduler 415 in this example is a set of instructions 415 in the program memory 405. The instruction passes from the program memory 405 via bus 406 to an instruction decoder 407. As discussed in FIG. 2, when a decoding process 404 decides what steps must be taken to execute the instruction, signals along data bus 410 may be sent from the decoder 407 to the data memory 411. Control signals 408 may be sent from the decoder 407 to the ALU 409. Control signals 414 may be sent from the ALU 409 to the program counter 403. Signals along data bus 410 may be transferred between the ALU 409 and the data memory 411. One or more operands may be transferred from the data memory 411 to the ALU 409. Especially in Von Neuman architectures, a single bus may perform the functions of the instruction bus 406 and the data bus 410, Some architectures may separate I/O data from memory data, in which the operand may come from an I/O peripheral 413. The ALU 409 may also send data 414 back to the program counter 403.

The ALU 409 calculates the operation commanded by the instruction decoder 407. The result of the ALU operation is stored via data bus 410 in the data memory 411 or transferred 412 to or from an I/O port 413. The flow of execution can change from time to time by operations that modify the program counter 403. Otherwise, the microprocessor 400 advances the program counter address to the next instruction.

In most microprocessors there is an interrupt control 401. When certain events occur, signals to the interrupt control 401 trigger an interruption in the default flow of instructions. A new address 402, which may be singular or may depend on the source of the interrupt signal, is transferred to the program counter 403 and execution of the interrupt service routine (ISR) begins. When the TSR completes, instruction execution resumes normally at the instruction following the previous instruction that was interrupted.

In this example embodiment, the interrupt control 401 may be activated when the AND gate 418 detects that a special instruction 421 has been decoded and also that the time interval 417 has expired in timer 416. When these two conditions are met the AND gate 418 will send a signal 419 to the interrupt control 401 to interrupt the current task. The AND gate may be a collection of transistors. The signal 419 may also act as a reset signal 420 to the timer 416. The reset signal 420 will reset the timer to zero. The scheduler code 415 will then switch to the next task.

FIG. 4 illustrates an embodiment block diagram of an augmented microprocessor. A new instruction is added to the set of instructions known to the decoder 407 or existing instructions are augmented with the marking means that the decoder can detect. In the ARM architecture, every instruction has a conditional execution mask. One way to embody the invention would be to assign an unused conditional execution mask value to the function of signaling a pre-emption opportunity.

In another example embodiment, a timer may be used to limit the amount of time that a task may execute instructions without interruption. The period of the timer 416 will be comparable to the timer in pre-emptive systems. The period of the timer 416 may be on an order of a few milliseconds. When the timer has expired, its output 417 is active. When the 417 output is active and the instruction decoder detects a pre-emption opportunity 415, an interrupt signal 419 is sent to the interrupt control 401. This signal resets the timer 420 and also causes the interrupt control 401 to invoke the scheduler.

Interrupts have many uses, including periodically invoking the scheduler in a pre-emptive multi-tasking system. It is useful to have a microprocessor executing more than one instruction stream concurrently. One example is cooperative multitasking, which may be used in PC operating systems and embedded systems.

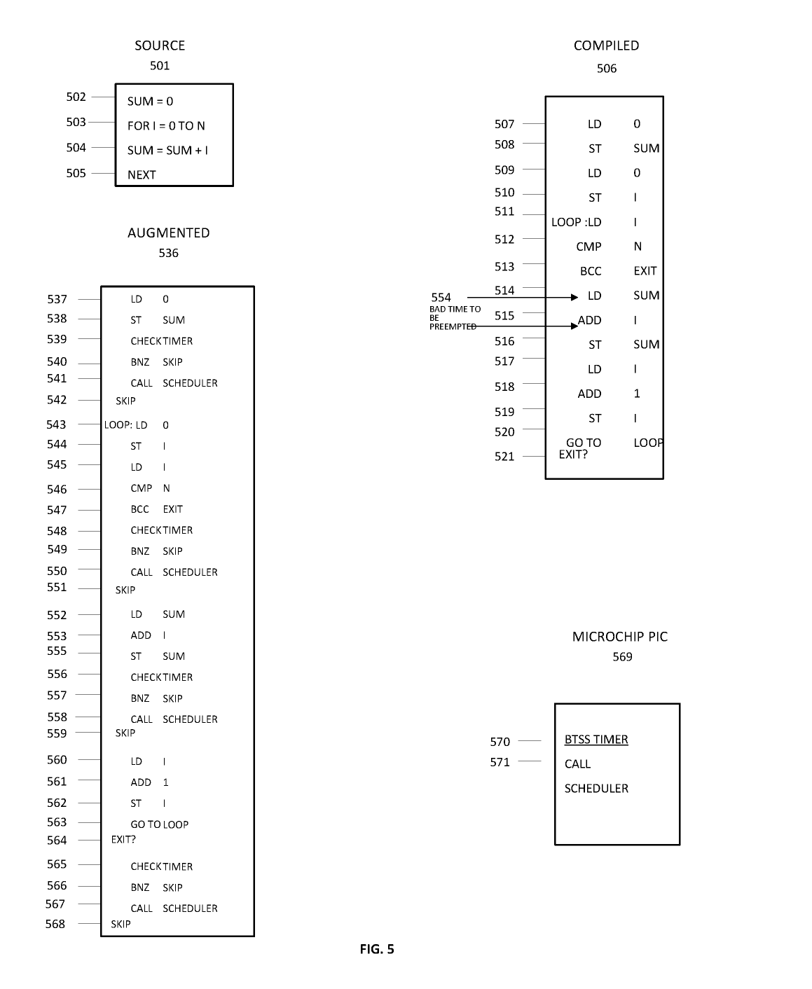

FIG. 5 shows an example of a problematic error due to pre-emption. The programmer normally writes code in a high-level language such as “C” or some equivalent. The programmer writes source code 501 comprising lines 502 through 505. From the perspective of the programmer, each line is an independent operation. But the microprocessor does not actually execute source lines. It executes low-level instructions such as machine code. A compiler translates the source code to a series of low-level instructions for direct execution by the microprocessor hardware. For instance, line 502 translates into lines 507-508 when compiled and lines 537 -538 at the machine code level. Line 503 translates into lines 509-513 when compiled and lines 543-547 at the machine code level. Line 504 is lines 514-520 when compiled and lines 551-555 and 559-564 at the machine code level. Line 505 is line 521 when compiled and line 568 at the machine code level. In the augmented example 536, extra code, 539-541, 548-550, 556-558, and 565-567 is inserted into the machine code to check the timer, branch skip if the timer has not expired, and call the scheduler if the timer has expired.

For example, the source line 504 adds the value of the variable “i” to the variable “Sum.” The compiler translates this to several instructions. Specific instructions vary by microprocessor, however, the example instructions used in this example for illustrative purposes shown as compiled code 506 are similar to those used in other architectures. The source line 504 in this example is translated into the three instructions 514, 515, and 516. As long as the memory location holding value of “SUM” is only accessed by one task, there is no problem if the flow of execution is interrupted. As mentioned earlier, the scheduler is responsible for saving the context of the processor, which includes the state of the ALU 309 as shown in FIG. 3, where a task is interrupted and restored. However, if the memory location is a shared resource, the situation can arise that two different tasks both modify SUM and that a second such task may pre-empt a first such task, thus modifying SUM between individual low-level instructions. In the FIG. 5 example, if the first task has just executed instruction 514 and loaded the value of SUM into the ALU, but then the scheduler timer expires and pre-empts the task, then the scheduler starts the second task, during its time-slice the second task modifies SUM. Eventually, the first task resumes control and executes instructions 515 and 516. Because the value of SUM being used by the first task was retrieved from the data memory before it was modified by the second task, when the first task writes its modified value of SUM back to data memory at instruction 516, the effect of the second task's modification is lost.

The problem illustrated in this kind of flaw does not occur deterministically and is difficult to predict or to detect. Programmers of pre-emptive multi-tasking systems must be constantly vigilant and aware that any task may execute any instructions between two low-level instructions of another.

An example embodiment is disclosed in FIG. 5 showing an augmented compiler 536. The emitted pre-emption opportunity is a series of standard instructions already available in the architecture. This series of instructions performs the steps of checking the timer and invoking the scheduler if the timer has expired. After the code representing each source line, e.g. after instructions 538, 547, 555, and 564, the compiler inserts instructions which test the state of the tinier at 539, 548, 556, and 565, respectively. The code will branch 540, 549, 557, and 566 around a call 541, 550, 558, and 567 to the scheduler if the timer has not expired, but does call the scheduler if the timer has expired.

The microchip PIC range of microcontrollers is especially suited to the embodiments disclosed with instruction sets that include several test-and-skip instructions. One of these instructions can be used to test the timer 570 and, if it has not expired, skips the following instruction which is a call to the scheduler 571. The compiler only has to insert these two instructions 569 after each source line.

Programmers of the example embodiments will have less need for special programming methods such as semaphores, mutexes, and critical sections compared to previous pre-emptive multi-tasking systems.

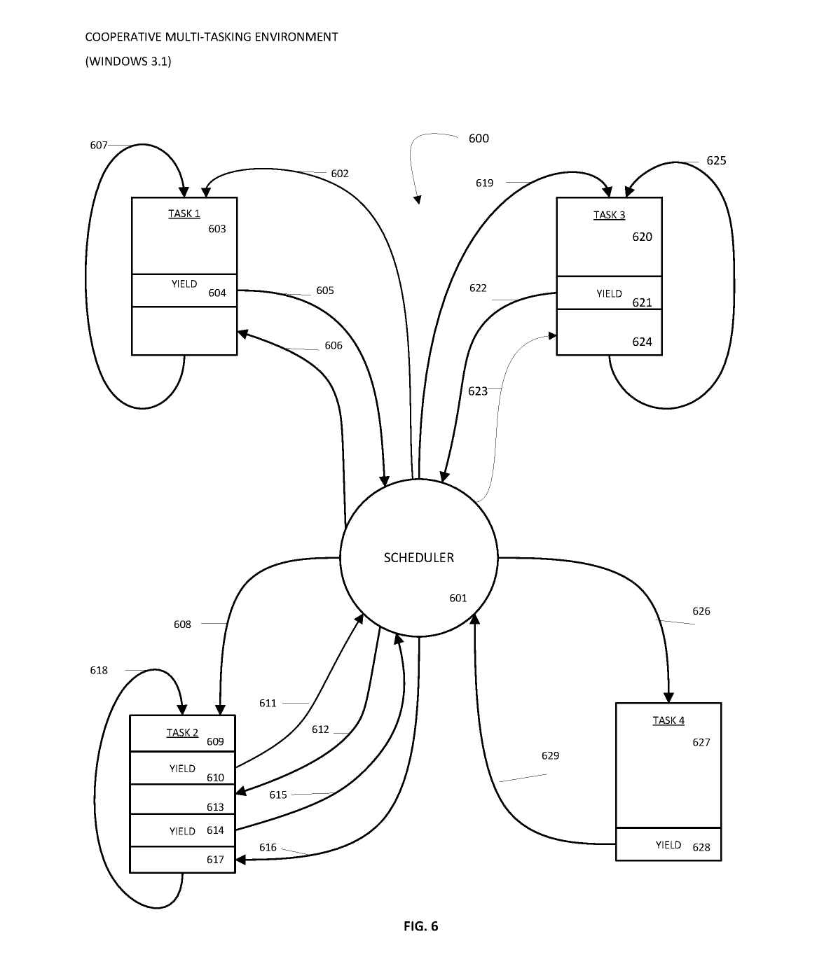

A cooperative multi-tasking environment 600 is illustrated in FIG. 6. The core of the system is a section of code known as the scheduler 601. The purpose of the scheduler 601 includes deciding which task is allocated use of the CPU at a given time. A common scheduling algorithm, especially in embedded systems, is the “round robin” algorithm where each task takes a turn executing a series of instructions.

In a cooperative system it is the responsibility of the individual tasks 603, 609, 620, and 627 to occasionally relinquish use of the CPU. The individual tasks 603, 609, 620, and 627 do this by calling a Yield() function 604, 610, 614, 621, and 628, respectfully. The Yield() function could be multiple Yield() functions at predetermined locations within each task. When a task yields, the flow of control is transferred 605, 611, 622, and 629 to the scheduler 601. The scheduler 601 chooses the next task to execute, such as Task 609, by transferring the flow of control 608 to that task. Task 609 eventually yields 610 and transfers control 611 to the scheduler 601. The scheduler 601 then transfers control 619 to task 620. When task 620 yields 621 control is transferred 622 to the scheduler 601. Scheduler 601 then transfers control 626 to task 627. When task 627 yields 628 control is transferred back to scheduler 601. In this example some tasks are in a loop 607, 618, and 619. Also, some task, such as task 609, may have a plurality of yields, 610 and 614, that transfer control back to the scheduler 611 and 615. The scheduler 601, when returning to Task 2, will restart where it left off by transferring control 612. or 616 to the task portion 613 or 617, depending on where in Task 2 the last yield function occurred.

This process repeats until it is again at task 603 to use the CPU. The scheduler 601 remembers the “context” of each interrupted task including the address of the Yield() instruction that last invoked the scheduler. When it is again the turn of task 603 to execute, control is transferred 606 to the code immediately filling the yield 604. At the typical speeds of modern CPU's all the tasks get CPU time to run their instructions. Although only one task is actually running at a time, the effect is that they are all running concurrently. One disadvantage of the cooperative paradigm is that, should one process fail to yield, all others are stalled.

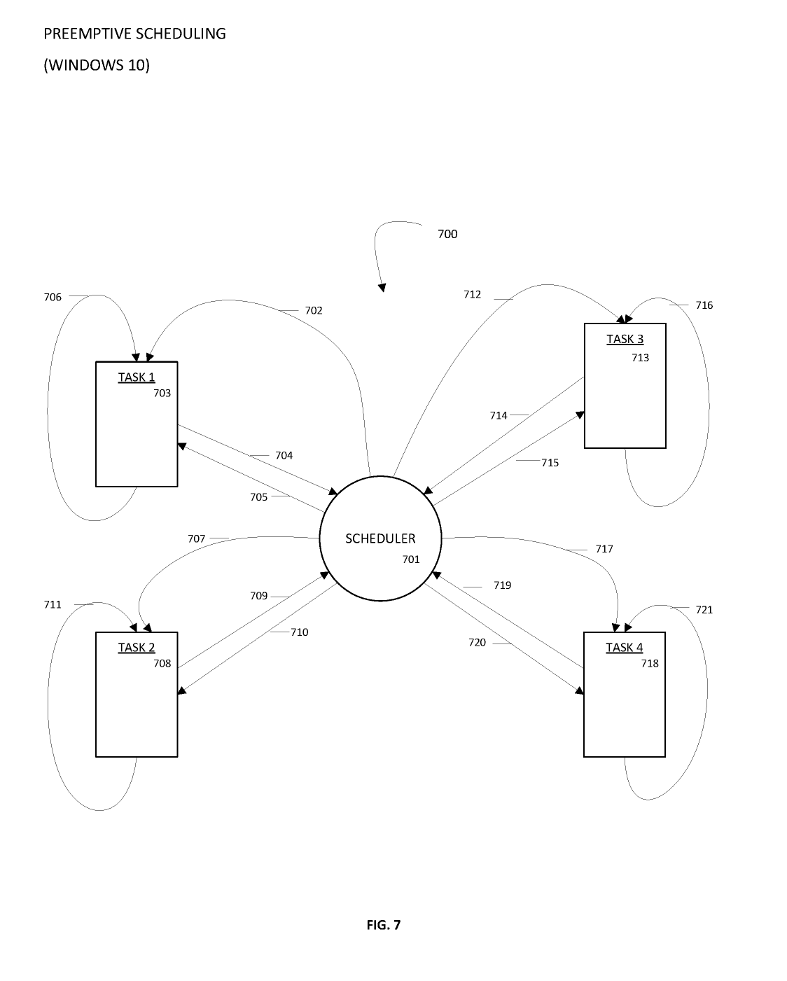

Another example multi-tasking paradigm is pre-emptive multi-tasking 700 as illustrated in FIG. 7. One of the differences between cooperative and pre-emptive multi-tasking is that the tasks do not decide when to yield to the scheduler 701. Only one flow of data can exist for each task because only one task can be executing at any time. Control 705 is given to Task 1 703 and control is transferred back 704 when the scheduler 701 pre-empts the task. The scheduler 701 then switches to Task 2 708 and gives it control 710 of the CPU and then transfers control back to the scheduler 709 when a predetermined preemption occurs. The scheduler 701 then switches to Task 3 713 and gives it control 715 of the CPU and then transfers control back to the scheduler 714 when a predetermined preemption occurs. The scheduler 701 then switches to Task 4 718 and gives it control 720 of the CPU and then transfers control back to the scheduler 719 when a predetermined preemption occurs. In this example all of the tasks are shown as having loops 706, 711, 716, and 721. An independent mechanism, such as a timer-driven interrupt, causes the flow of execution to transfer from a task 703, 708, 713, or 718 to the scheduler 701. A typical interval for pre-emption is on the order of 10 milliseconds. As with cooperative multi-tasking, the scheduler decides which task will execute next and transfers control 707 to that task. As with cooperative multi-tasking, the scheduler returns control to an interrupted task immediately following the point at which it was interrupted.

Since the pre-eruption interrupt occurs asynchronously, and effectively unpredictably from each task's point of view, the programmer of tasks for a pre-eruptive system must be aware that execution could be interrupted at any moment for an indeterminate amount of time. Most critically, the state of any shared resources such as memory locations could be changed by another task.

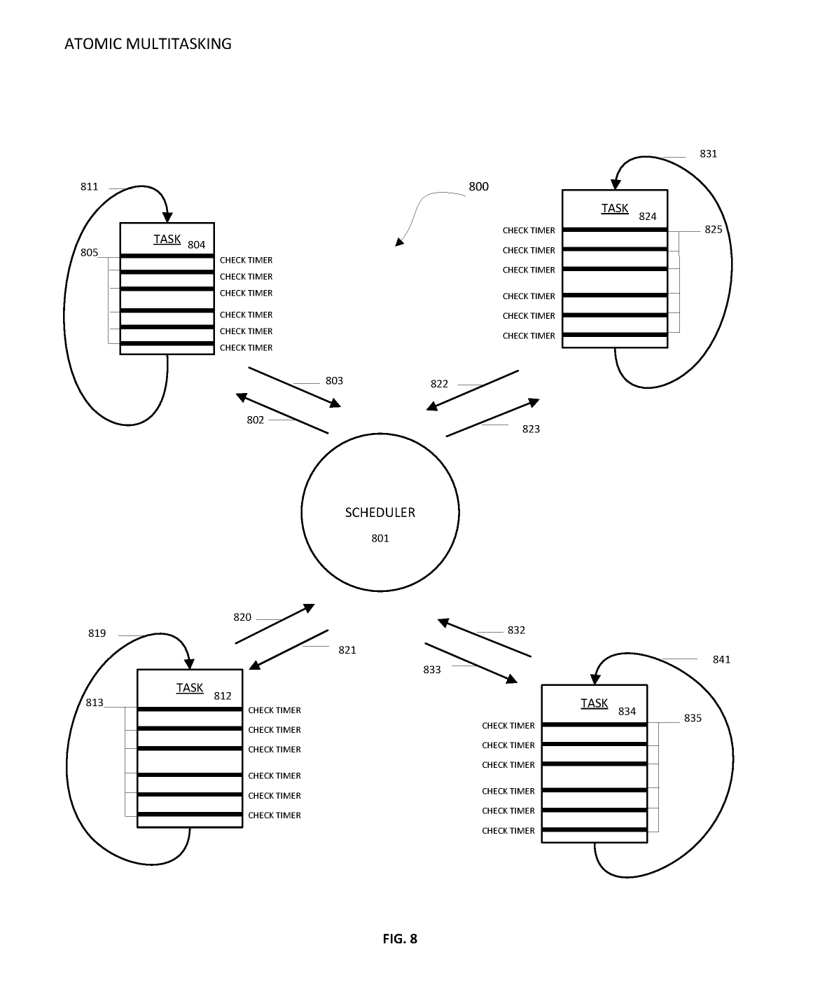

For this hardware function to operate, the compiler must be augmented to insert the special instructions or markings into the low-level object code. FIG. 8 illustrates an example embodiment of atomic multitasking 800. The object code of each task 804, 812, 824, and 834 has pre-emption opportunities, 805, 813, 825, and 835, inserted following the object code equivalent to each source code line. When execution reaches one of these opportunities AND the timer has expired, the scheduler 801 is invoked. Scheduler 801 transfers control to 802, 821, 823, and 833 each task and then from 803, 820, 822, and 832 each task based on the presence of the pre-emption code in conjunction with a timer expiring. One advantage of this system is that it has improved performance over inserting a plurality of Yield() functions in the code that could result in poor system performance. Execution of the scheduler, even if it decides to return to the task that just invoked it, requires tens or even hundreds of instructions to be executed for each Yield() function. In this example embodiment a typical source line translates into 3 or 4 instructions. Because in this example embodiment a task is only pre-empted when a pre-emption opportunity coincides with the timer, the system performance losses are minimized when switching from one task to the next. Furthermore, if the pre-emption opportunity is implemented as a marker on instructions that are needed for the program anyway, then there is no impact on the system performance. Therefore, the current example embodiment may result in an order of magnitude increase in available computing cycles to run tasks rather than executing Yield() functions.

The example embodiments disclosed achieve tractable predictability of a cooperating multi-tasking paradigm in that the programmer does not constantly have to anticipate when code is pre-empted, but the programmer does not have to slow down the system with unnecessary Yield() functions.

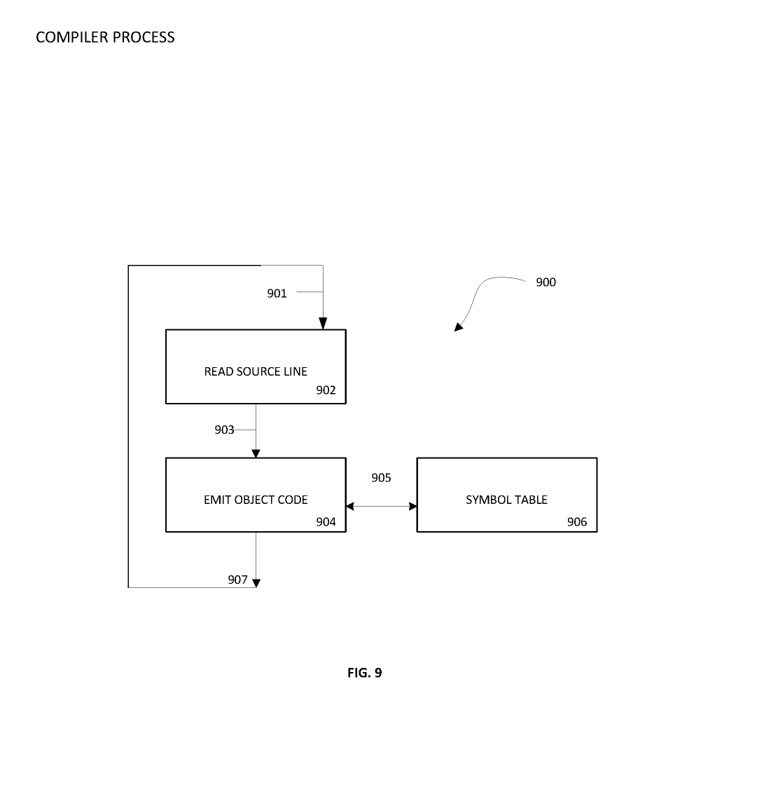

An example embodiment is disclosed in FIG. 9 showing the hardware embodiment 900 requiring the cooperation of the compiler. The compiler reads lines of source code 902 sequentially and, through complex internal operations 903, emits object code instructions 904 to be executed by the microprocessor. The emitting object code 904 may interact 906 with the symbol table 906. The process repeats 907, starting with the next source line 901, until the end of the source code is reached.

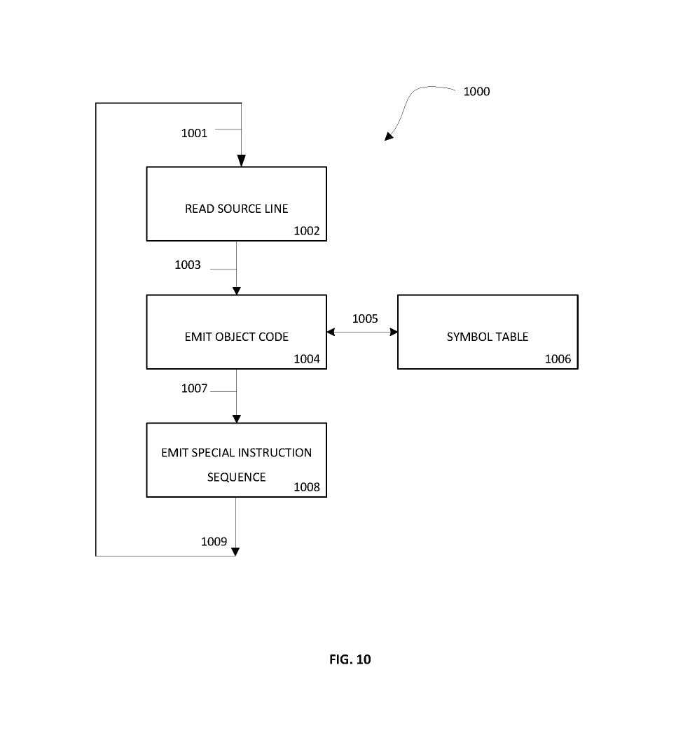

A compiler modified to support atomic multitasking 1000 of the claims is illustrated in FIG. 10. The compiler starting with a line of source code 1001 reads the source line 1002, through complex operations 1003 emits object code 1004, references 1005 the object code with the symbol table 1006. The compiler then inserts the pre-emption opportunity 1007 after emitting the low-level object code instructions 1004 to form a special instruction sequence 1008. The special instruction sequence 1008 may have the pre-emption opportunity as a special instruction or a marker on the last instruction implementing the line emitted at 1004. This process repeats 1009 for each line of source code.

Although the invention has been described in terms of particular embodiments which are set forth in detail, it should be understood that this is by illustration only and that the invention is not necessarily limited thereto. The alternative embodiments and operating techniques will become apparent to those of ordinary skill in the art in view of the present disclosure. Accordingly, modifications of the invention are contemplated which may be made without departing from the spirit of the claimed invention.

what is claimed is:

1. A system of automatic data processing comprising:
a CPU which executes instructions;
a first timer establishing a time interval;
a means to change the sequence of instruction execution;
a means to manage the execution of a plurality of tasks;
an instruction decoder which recognizes a special condition;
wherein when the time interval has passed and the special condition is detected the sequence of instruction execution changes and thus the CPU stops executing the instructions comprising one task and begins executing the instructions comprising a second task.

2. The apparatus of claim 1 further comprising data memory.

3. The apparatus of claim 1 further comprising program memory.

4. The apparatus of claim 1 further comprising an input/output interface.

5. The apparatus of claim 1 further comprising an Arithmetic Logic Unit.

6. The apparatus of claim 1 further comprising a bus for sending a plurality of signals from the data memory to the Arithmetic Logic Unit.

7. The apparatus of claim 1 further comprising a second timer.

8. The apparatus of claim 7 wherein the second timer is the first timer with a comparison means which triggers preemption when the count value exceeds a second predetermined count that is greater than the first predetermined count even if the instruction decoder has not detected the special condition.

9. The apparatus of claim 1 wherein the special condition is a special-purpose instruction.

10. The apparatus of claim 1 wherein the special condition is a modified version of an ordinary instruction.

11. The apparatus of claim 10 wherein the instruction modification is a special-purpose bit in the instruction word.

12. The apparatus of claim 10 wherein the instruction modification is a special value of a multi-bit field of the instruction word.

13. A method for invoking a multi-tasking scheduler in an operating system running on a CPU comprising:
running a first task originally written in high-level instructions and subsequently translated into a series of low-level instructions;
concurrently measuring an interval of time;
detecting the concurrence of the end of the sequence of low-level instructions representing a plurality of high-level instructions and the expiration of the time interval;
wherein upon on such detection, reconfiguring the CPU to execute the instructions of a second task.

14. The method of claim 13 where the plurality of high-level instructions is a sing line of text encoding a high-level computer language.

15. The method of claim 13 wherein the end of a first sequence of low-level instructions representing a plurality of high-level instructions and the beginning of a subsequent sequent of low-level instructions representing a subsequent plurality of high-level instructions is delimited by a compiler which translates said high-level instructions into functionally equivalent sequences of low-level instructions.

16. The method of claim 13 wherein the end of a first sequence of low-level instructions representing a plurality of high-level instructions and the beginning of a subsequent sequent of low-level instructions representing a subsequent plurality of high-level instructions is delimited by a post-processing software program which modifies the output of a compiler which translates said high-level instructions into functionally equivalent sequences of low-level instructions.

17. The method of claim 13 wherein the interval of time is measured by a hardware timer or counter.

18. The method of claim 13 wherein the interval of time is measured by a software interrupt routine invoked periodically by a periodic interrupt and which counts the number of such invocations to measure intervals of time.

19. The method of claim 13 wherein the reconfiguration of the CPU is performed by a small subprogram which saves the state of the CPU as it was when executing a first task and restores the state of the CPU to that which it needs to be to execute a second task.

20. The method of claim 19 wherein the subprogram is invoked by an interrupt.

21. The method of claim 15 wherein the delimiting of the two sequences of low-level instructions is in the form of a special low-level instruction recognized by a CPU implemented to embody the invention which causes the invocation of the scheduler if the time interval of claim 1 has also expired.

22. The method of claim 15 wherein the delimiter is a modification to the last instruction of the first sequence or the first instruction of the second sequence.

23. The method of claim 15 wherein the delimiter is a short sequence of standard instructions of a CPU which has not been specifically modified to embody the invention.

24. The method of claim the modification is the modification of a special bit.

25. The method of claim 22 wherein the modification is a special value of a multi-bit sub-field of the instruction.

26. The method of claim 13 wherein the concurrence triggers an interrupt.

27. The method of claim 13 further comprising reconfiguring the CPU at the end of a second, longer, time interval if the concurrence does not occur within that longer time.
